(19) United States
(12) Patent Application Publication
(10) Pub. No.: US 2006/0288653 A1
(43) Pub. Date: Dec. 28, 2006

(54) Window and/or door frame having conduit

(76) Inventor: Gary T. Mimnaugh, Lake Oswego, OR (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(21) Appl. No.: 11/168,132

(22) Filed: Jun. 27, 2005

(51) Int. Cl. E06B 7/14

(52) U.S. Cl. 52/209

(57) ABSTRACT

Embodiments of the present invention provide conduits within a window and/or door frame to provide access, for example, for electrical purposes, and/or other purposes, during installation, and in some embodiments, post installation.

### TECHNICAL FIELD

Embodiments of the present invention relate to construction materials, such as window and/or door frames, and in particular to window and/or door frames having conduits and devices associated therewith.

### BACKGROUND

During initial construction of homes and other buildings, and/or in the process of remodeling existing structures, windows and doors may be installed. Due to the operational requirements of windows and doors, the construction and installation processes should generally be performed precisely to provide a good fit to ensure proper operation of the window or door, as well as to ensure that energy efficiency is not compromised. Once installation is complete, access to portions of the window or door frame may be limited due to the desire to maintain the integrity of the window or door, as well as to avoid damage associated with manipulating the frame post-installation.

### BRIEF DESCRIPTION OF THE DRAWINGS

Embodiments of the present invention will be readily understood by the following detailed description in conjunction with the accompanying drawings. To facilitate this description, like reference numerals designate like structural elements. Embodiments of the invention are illustrated by way of example and not by way of limitation in the figures of the accompanying drawings.

FIG. 1 is a perspective view of a window or door frame in accordance with an embodiment of the present invention;

FIG. 2 is a perspective view of a window or door frame in accordance with an embodiment of the present invention;

FIG. 3 is a cross-sectional view of a window or door frame in accordance with an embodiment of the present invention with a conduit providing access for electrical communication with an accessory device;

FIG. 4 is a view of a window or door frame in which a marking provides an indication of the location of a conduit;

FIG. 5 is a cross-sectional view of a window or door frame and associated grommet in accordance with an embodiment of the present invention;

FIG. 6 is a perspective view of a grommet in accordance with an embodiment of the present invention;

FIG. 7 is a perspective view of a window or door frame with an integral channel in accordance with an embodiment of the present invention;

FIG. 8 is a perspective view of a window or door frame with an integral channel and an associated flashing in accordance with an embodiment of the present invention; and

FIG. 9 is a perspective view of a window or door frame with an integral interior channel conduit in accordance with an embodiment of the present invention.

### DETAILED DESCRIPTION OF EMBODIMENTS OF THE INVENTION

In the following detailed description, reference is made to the accompanying drawings which form a part hereof wherein like numerals designate like parts throughout, and in which is shown by way of illustration embodiments in which the invention may be practiced. It is to be understood that other embodiments may be utilized and structural or logical changes may be made without departing from the scope of the present invention. Therefore, the following detailed description is not to be taken in a limiting sense, and the scope of embodiments in accordance with the present invention is defined by the appended claims and their equivalents.

Embodiments of the present invention provide conduits within a window and/or door frame to provide access, for example, for electrical purposes, and/or other purposes, during installation, and in some embodiments, post installation.

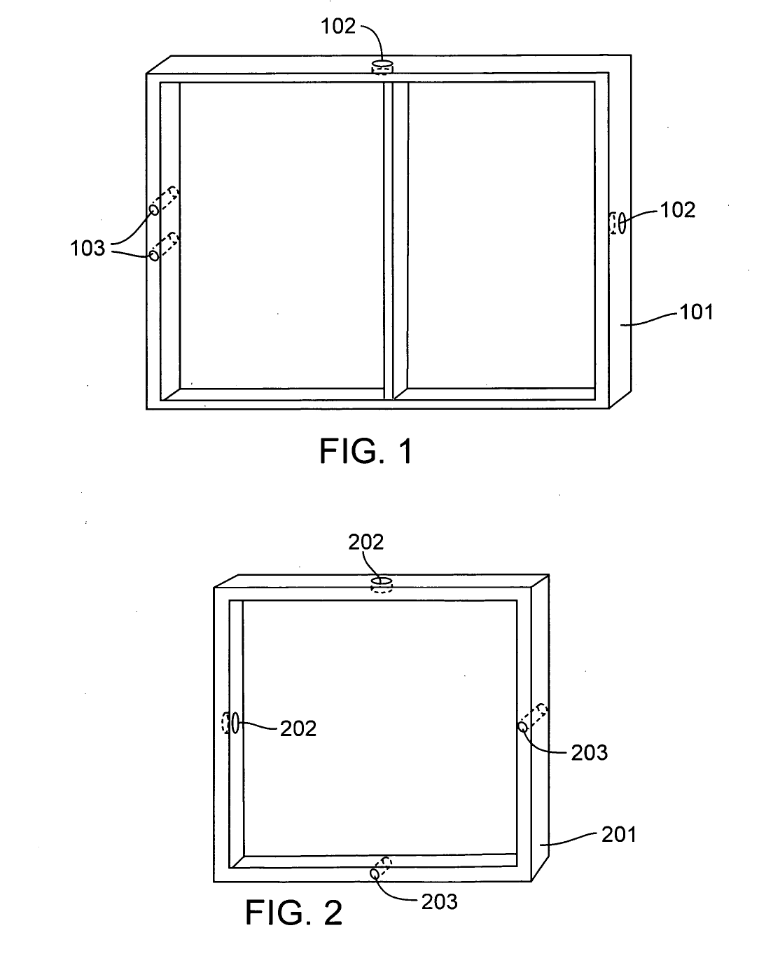

FIG. 1 shows an exemplary frame of manufacture 101 (hereinafter, simply frame) with conduits 102 and conduits 103, pre-configured therein at a manufacturing site, at manufacturing time. Conduits 102 may be referred to as transverse conduits as they provide post-installation access across a framing element of frame 101, into the interior space framed by frame 101, as shown. Conduits 103 may be referred to as longitudinal conduits as they provide post-installation access through a framing element of frame 101, connecting the exterior space of frame 101 (in particular, the proximal exterior space), as shown.

FIG. 2 shows an exemplary frame 201 with conduits 202 and conduits 203. Conduits 202 may be referred to as transverse conduits as they provide access across a framing element of frame 202, as shown. Conduits 203 may be referred to as longitudinal conduits as they provide access through a framing element of frame 201, as shown.

FIGS. 1 and 2 show four conduits each, although it should be appreciated based on the teachings of embodiments of the present invention that any suitable number of conduits may be provided, such as 1, 2, 3, or more. In addition, the sizes, locations and orientations of the conduits in FIGS. 1 and 2 are shown for exemplary purposes, and, as such, it should be appreciated that, in accordance with embodiments of the present invention, conduits may be provided in various sizes, locations and orientations depending on the desired application. Conduits according to embodiments of the present invention may be uniform in shape, tapered or irregular. Each conduit may be independent of any other conduit in size, shape, location and/or orientation. In accordance with embodiments of the present invention, conduits may be small enough to allow the passage of a single wire, or may be large enough to allow multiple wires or other devices to pass through.

Embodiments of the present invention may be used with a variety of door and/or window frames, such as multi-panel, hinged, sliding, and swinging windows or doors. According to embodiments of the present invention, window and/or door frames may be constructed from any suitable material including wood, plastic, such as vinyl, metal, such as aluminum, composite materials, etc.

According to embodiments of the present invention, a conduit may be configured in a frame during manufacture of the frame. In an embodiment of the present invention, a conduit may be configured from a separate material that may be inserted into an opening configured in the frame. For example, a tubular conduit may be inserted into an opening configured in a frame. Such a tubular conduit may be made from any suitable material, such as wood, plastic, such as vinyl, polyethylene, etc., rubber, metal, such as aluminum, composite materials, etc. Further, such a tubular conduit may be removable, or configured to remain in place once positioned in the frame.

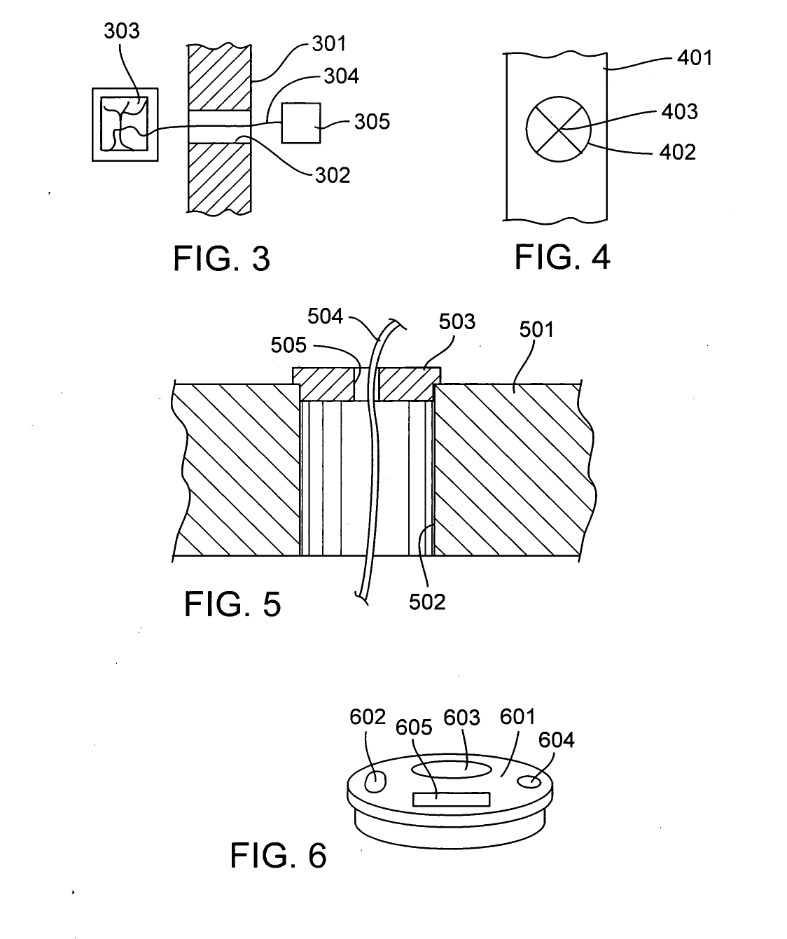

FIG. 3 is a cross-sectional view of a window or door frame 301 in accordance with an embodiment of the present invention. Frame 301 has conduit 302 with wire 304 passing through. Although only wire 304 is shown, in embodiments of the present invention, more than one wire may pass through conduit 302 as desired for a particular application. Wire 304 provides electrical communication between power source 303 and an associated accessory device 305. Power source 303 may be any suitable power source, including an electrical junction box, a wall outlet, etc. Associated accessory device 305 may be one or more device, such as a door bell, a push-button door or window opener, automated blinds, a sensor, such as a motion sensor, a motor, a remote controlled device, a radio frequency identification device, an additional power source, etc.

As may be seen from the electrical communication of accessory device 305 with power source 303 via wire 304, conduit 302 provides a readily available passage for such a communication to occur without the need for creating a passage during or post installation. Providing a conduit during production of the frame allows the conduit to be properly constructed according to the desired specifications, including, for example, size, shape, orientation and location. Furthermore, most frame manufacturers disclaim warranties for a frame that has been altered after purchase. Thus, manufacturing a door or window frame with integrated conduits may allow the warranties to be maintained for the owner.

In embodiments of the present invention in which a wire or other device extends from a conduit, an opening of the conduit may be caulked or sealed, for example, with a caulk, sealant and/or insulating foam, such as a polyurethane, silicone, etc.

FIG. 4 provides a view of a window or door frame 401. Dimple 402 may be raised, depressed, or flush with the surface of frame 401 and may provide an indication of the location of a conduit. Marking 403 may also be used to provide a further indication of the location of the conduit. Although an “X” is shown as marking 403, any suitable marking may be used.

Dimple 402 may be the same material as frame 401 or a different material from frame 401. In an embodiment of the present invention, dimple 402 may provide a covering to a conduit, or may enclose an end of a conduit, such that the conduit may be accessed if needed by drilling or punching through dimple 402. For example, in an embodiment of the present invention, a frame, such as a vinyl door frame, may be provided with a stamp depressed into the surface of the frame that indicates the location of a conduit behind that stamp.

FIG. 5 is a cross-sectional view of a window or door frame 501 and associated grommet 503 in accordance with an embodiment of the present invention. Grommet 503 is configured to cap an opening of conduit 502 as shown. Grommet 503 is configured with conduit 505 to allow wire 504 to pass through. While grommet 503 is shown raised from the surface of frame 501, according to an embodiment of the present invention, a grommet may fit flush with the surface of frame 501. According to embodiments of the present invention, grommets may be configured to couple with a conduit via any suitable engagement mechanism, including threadable engagement, press-fit engagement, snap-fit engagement, etc.

FIG. 6 is a perspective view of a grommet 601 in accordance with an embodiment of the present invention. Grommet 601 has openings 602, 603, 604, and 605 extending through. In an embodiment of the present invention, grommet 601 provides adaptability for use with various accessory devices, wires, etc., due to the variety of shapes and sizes of conduits 602, 603, 604, and 605. Grommet 601 is shown as a round or oval shape, but may be configured with a different shape, such as square or rectangular, to fit differently shaped conduits. Openings 602, 603, 604, and 605 are shown for exemplary purposes, but, according to embodiments of the present invention, any suitable number, sizes, shapes, orientations, and/or locations may be provided depending on the particular desired application.

FIG. 7 is a perspective view of a window or door frame 701 with an integral channel 703 in accordance with an embodiment of the present invention. Channel 702 provides access to conduit 702 from which exits wires 704. Channel 703 provides a groove or path in which to run one or more wires 704 beneath the surface of frame 701.

FIG. 8 is a perspective view of a window or door frame 801 with an integral channel 803 and an associated flashing 805 in accordance with an embodiment of the present invention. Flashing 805 may be coupled to frame 801 in a variety of ways, including snapping or sliding into place, or being nailed, stapled, screwed, glued, etc. Flashing 805 may provide a protective or aesthetic covering for wire 804, and may further cover associated conduits (not shown). In an embodiment of the present invention, flashing 805 may be removable to facilitate easy access to wire 804, and to associated conduits (not shown). According to embodiments of the present invention, flashing may be constructed of plastic, such as vinyl, metal, such as aluminum, rubber, etc.

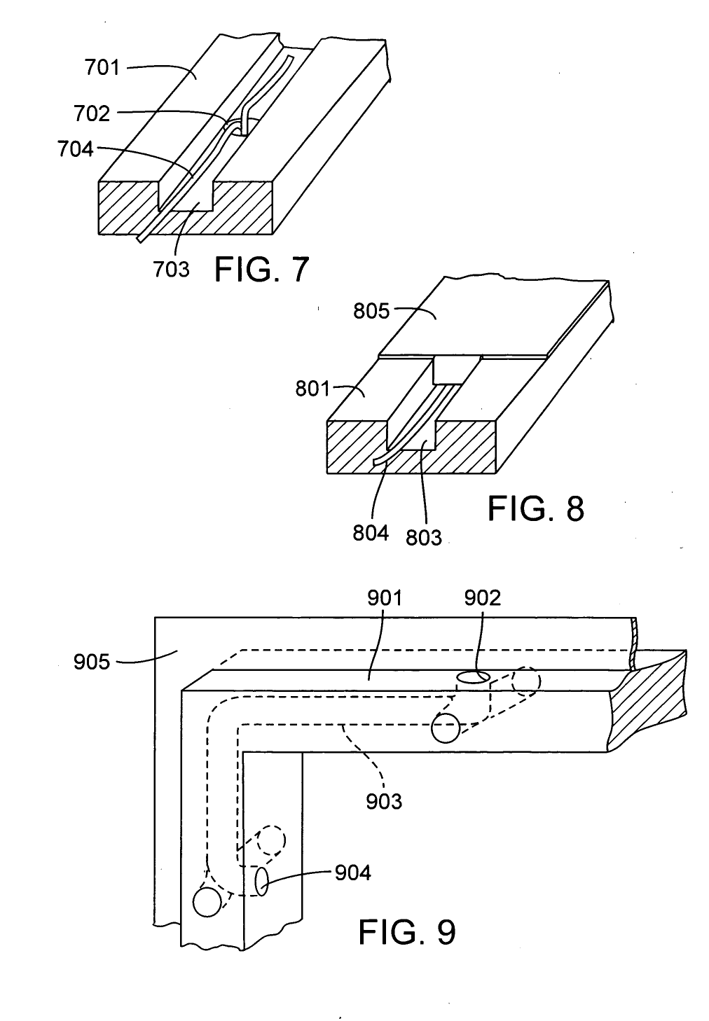

FIG. 9 is a perspective view of a window or door frame 901 with an integral interior channel conduit 903 in accordance with an embodiment of the present invention. Frame 901 is shown with a fin 905 that may be used to couple frame 901 to at least a portion of the perimeter of the opening present or constructed in a wall for the installation of frame 901. Fin 905 may be coupled to the perimeter of such an opening by snapping or sliding into place, or being nailed, stapled, screwed, glued, etc. Integral interior channel conduit 903 is shown with multiple potential openings, such as conduit opening 902 on an upper, exterior surface of frame 901, and conduit opening 904 on an inner surface of frame 901. Integral interior channel conduit 903 may be provided with any suitable number of openings in a variety of locations, such as those shown in FIG. 9. In an embodiment of the present invention, integral interior channel conduit 903 allows wires (not shown) to be run in the interior of frame 903, and to exit at the conduit openings, such as 902 and 904.

In embodiments of the present invention, a frame may be configured with an integral interior channel conduit. Such a conduit may be constructed directly in the frame or may be configured from a separate material such as wood, plastic, such as vinyl, polyethylene, etc., rubber, metal, such as aluminum, composite materials, etc.

In an embodiment of the present invention, a frame may be provided with a conduit that has a substantially continuous axial orientation. A substantially continuous axial orientation refers to a conduit that extends through or across a frame in a substantially straight line, at any suitable degree or slant relative to the plane of the frame or the surface of the floor or ceiling. An example of a conduit having a substantially continuous axial orientation may be found in FIG. 2, conduit 203. In an embodiment of the present invention, a frame may be provided with a conduit that has a discontinuous axial orientation. A discontinuous axial orientation refers to a conduit that extends through or across a frame, but where the direction of the primary axis of the conduit changes in at least one location along the conduit. An example of a conduit having a discontinuous axial orientation may be found in FIG. 9, conduit 903.

According to an embodiment of the present invention, a method of installing an accessory device is provided using a door or window frame in accordance with embodiments of the present invention. In such a method, a door or window frame may be installed such that, when installed, the conduit(s) in the frame provide access from the exterior of one side of the frame, through the frame to a power source. An accessory device may be installed before, during or after installation of a window or door frame, due in part to the presence of the conduit(s). A wire may be run through a conduit, and electrically connected at a first end to a power source and at a second end to an accessory device. According to embodiments of the present invention, accessory devices may include a door bell, a push-button door or window opener, automated blinds, a sensor, such as a motion sensor, a motor, a remote controlled device, a radio frequency identification device, an additional power source, etc.

Although certain embodiments have been illustrated and described herein for purposes of description of the preferred embodiment, it will be appreciated by those of ordinary skill in the art that a wide variety of alternate and/or equivalent embodiments or implementations calculated to achieve the same purposes may be substituted for the embodiments shown and described without departing from the scope of the present invention. Those with skill in the art will readily appreciate that embodiments in accordance with the present invention may be implemented in a very wide variety of ways. This application is intended to cover any adaptations or variations of the embodiments discussed herein. In particular, while for ease of understanding the present invention has been described with substantially rectangular closed embodiments, the present invention also anticipates non-rectangular and/or open embodiments, including but not limited to triangular, pentagon, hexagon, octagon and U-shaped embodiments. Therefore, it is manifestly intended that embodiments in accordance with the present invention be limited only by the claims and the equivalents thereof.

What is claimed is:

1. A frame of manufacture for a window or door, comprising:
a plurality of framing elements selectively pre-coupled, at a manufacturing site, to form at least a portion of the frame; and
a conduit pre-configured in one or more of said framing elements, at a manufacturing site, to provide post-installation access to at least one of an interior and a proximally exterior space of the frame.

2. The frame of claim 1, wherein said conduit is a transverse conduit.

3. The frame of claim 1, wherein said conduit is a longitudinal conduit.

4. The frame of claim 1, wherein said conduit comprises a tubular insert inserted into an opening configured in a first surface of said frame elements, and extending through one or more of said frame elements to a second surface of said frame elements.

5. The frame of claim 1, wherein said conduit comprises at least a first end and a second end, and wherein said frame further comprises a grommet coupled to at least one of said first and second ends.

6. The frame of claim 5, wherein said grommet is removable.

7. The frame of claim 5, wherein said grommet comprises at least one opening.

8. The frame of claim 1, wherein said grommet comprises a plurality of openings.

9. The frame of claim 8, wherein said grommet comprises at least one opening that differs from at least one other opening of said grommet in at least one of size and shape.

10. The frame of claim 1, wherein said conduit comprises at least a first end and a second end, and wherein at least one of said first and second ends is enclosed.

11. The frame of claim 10, wherein said enclosed end comprises a visible location indication of said conduit.

12. The frame of claim 1, wherein said conduit is configured with a substantially continuous axial orientation in said frame.

13. The frame of claim 1, wherein said conduit is configured with a discontinuous axial orientation in said frame.

14. The frame of claim 13, wherein said conduit comprises an integral interior channel conduit.

15. The frame of claim 1, wherein at least one of said framing elements comprises an integral channel.

16. The frame of claim 15, wherein said conduit comprises at least a first end and a second end, wherein at least one of said first and second ends is located in said integral channel.

17. The frame of claim 15, further comprising a flashing removably coupled to said integral channel, and removably covering at least a portion of said integral channel.

18. A method for manufacturing a door or window frame, comprising:
joining a plurality of framing elements at a manufacturing site to form at least a portion of the door or window frame; and
pre-configuring a conduit in one or more of the framing elements, at a manufacturing site, to provide post-installation access to at least one of an interior and a proximally exterior space of the door or window frame.

19. The method of claim 18, wherein pre-configuring a conduit comprises pre-configuring a transverse conduit.

20. The method of claim 18, wherein pre-configuring a conduit comprises pre-configuring a longitudinal conduit.

21. The method of claim 18, wherein pre-configuring a conduit comprises pre-configuring a conduit comprising a first end and a second end, and wherein at least one of said first and second ends is enclosed.

22. The method of claim 18, wherein pre-configuring a conduit comprises pre-configuring a conduit configured with a substantially continuous axial orientation in said frame.

23. The method of claim 18, wherein pre-configuring a conduit comprises pre-configuring a conduit configured with a discontinuous axial orientation in said frame.

24. The method of claim 18, wherein pre-configuring a conduit comprises pre-configuring an integral interior channel conduit.

25. A method of coupling an accessory device to a power source through a frame, comprising:
providing a frame for a window or door configured with at least one conduit, said conduit having at least a first end and a second end;
running an electrical wire through said conduit, said electrical wire having a first end and a second end, wherein said first end of said electrical wire extends from said first end of said conduit and said second end of said electrical wire extends from said second end of said conduit;
coupling said first end of said electrical wire to a power source; and
coupling said second end of said electrical wire to said accessory device.

26. The method of claim 25, further comprising providing a sealant to seal at least one of said first end and said second end of said conduit.

27. The method of claim 25, further comprising drilling or punching through a covering or enclosure of at least one of said first end and said second end of said conduit prior to running an electrical wire through said conduit.
